(19) United States
(12) Patent Application Publication
(10) Pub. No.: US 2005/0249080 A1
(43) Pub. Date: Nov. 10, 2005

(54) Method and system for harvesting a media stream

(75) Inventors: Jonathan T. Foote, Menlo Park, CA (US); Matthew L. Cooper, San Francisco, CA (US)

Correspondence Address: FLIESLER MEYER, LLP, FOUR EMBARCADERO CENTER, SUITE 400, SAN FRANCISCO, CA, 94111, US

(73) Assignee: Fuji Xerox Co., Ltd., Tokyo (JP)

(21) Appl. No.: 10/841,082

(22) Filed: May 7, 2004

(51) Int. Cl. G11B 7/085

(52) U.S. Cl. 369/59.1; 369/124.01

(57) ABSTRACT

Systems and methods in accordance with the present invention can be applied to generate a personal media library of media segments from a media stream. A method in accordance with one embodiment can comprise receiving the media stream, identifying one or more novelty points within the media stream and creating a plurality of media segments based on said one or more novelty points. The method can further be applied to compile a playlist or substitute media stream organizing such stream as desired, eliminating redundant media clips and discarding advertisements.

### CROSS-REFERENCE TO RELATED APPLICATIONS

This U.S. patent application incorporates by reference all of the following issued patents and co-pending applications:
U.S. Pat. No. 6,542,869, entitled “Method for Automatic Analysis of Audio Including Music and Speech,” issued Apr. 1, 2003, to Foote;
U.S. patent application Ser. No. 09/947,385, entitled “Systems and Methods for the Automatic Segmentation and Clustering of Ordered Information,” filed on Sep. 7, 2001;
U.S. patent application Ser. No. 10/086,817, entitled “Method for Automatically Producing Optimal Summaries of Linear Media,” filed on Feb. 28, 2002 [Attorney Docket No. FXPL-01031 US0];
U.S. patent application Ser. No. 10/271,407, entitled “Summarization of Digital Files,” filed on Oct. 15, 2002 [Attorney Docket No. FXPL-01046US0]; and
U.S. patent application Ser. No. 10/405,192, entitled “Method and System for Retrieving and Sequencing Music by Rhythmic Similarity,” filed on Apr. 1, 2003 [Attorney Docket No. FXPL-01045US1].

### TECHNICAL FIELD

The present invention relates to analyzing and organizing broadcasted and streamed media.

### BACKGROUND

As consumers have begun collecting and storing mass amounts of software and data, particularly media data such as images, music, and video files, and the like, high capacity data storage has become cheap and ubiquitous. High capacity data storage offers the ability to not only receive, play, and discard information broadcasted or streamed, but also to permanently store the information broadcasted or streamed. For example, a 160 GB disk combined with MP3 encoding can store 100 days of continuous stereo audio from a streaming source, or 20 days of five separate streaming sources. The result can be a colossal collection of digital information, that while thorough, can create a nearly impenetrable block of “1's” and “0's”, such that finding a particular song or news broadcast is as confusing as finding a book in the Library of Congress without a card catalog. Available tools, such as Streamcast or StreamRipper, rely on metadata to identify portions of a streamed broadcast, and are limited to streamed MP3's having metadata encoded within the stream. Metadata itself is sometimes incomplete or inaccurate, and often inconsistent. Further, where metadata is included in a media stream, the metadata is limited in its ability to characterize a work. Thus, metadata alone does not support many other useful management functions, such as automatic playlist generation or sequencing songs by rhythmic similarity.

### BRIEF DESCRIPTION OF THE FIGURES

Further details of embodiments of the present invention are explained with the help of the attached drawings in which:

FIG. 1 is a flowchart illustrating a system and method of generating a media library in accordance with an embodiment of the present invention;

FIG. 2 is a flowchart illustrating an exemplary technique for segmenting a data block obtained from a digital stream;

FIG. 3 illustrates a similarity matrix data structure for use with the exemplary technique illustrated in FIG. 2;

FIG. 4 is an exemplary plot of a novelty score calculated for a data block obtained from a digital stream; and

FIG. 5 is an exemplary plot of a beat spectrum calculated for a data block obtained from a digital stream.

### DETAILED DESCRIPTION

Receiving Signals/Signal Decoding

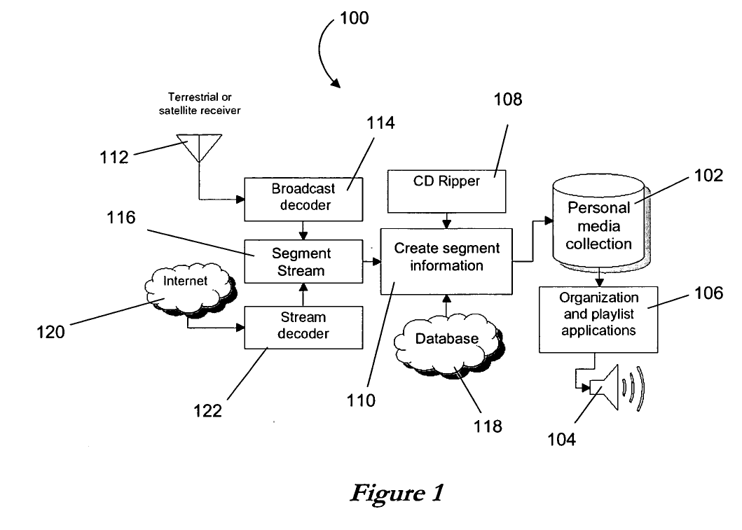

FIG. 1 is a flowchart of a system and method 100 in accordance with one embodiment of the present invention for receiving, conditioning, analyzing, identifying and/or organizing a media stream, or a portion of the media stream to enable selective playback, to produce a pared and customized stream, and/or to generate a media library. A media stream for use with systems and methods of the present invention can be acquired from either an analog or digital source, for example, using a terrestrial or satellite receiver 112. Alternatively, a media stream can comprise a web telecast (webcast) or other broadcast delivered over the Internet 120, or a local area network (LAN).

A media stream can be captured and decoded to produce a digital stream for analysis. For example, a media stream comprising an analog radio (or television) broadcast can be captured by a terrestrial receiver 112 and digitized using an analog-to-digital converter. Alternatively, a media stream comprising an encoded digital broadcast can be captured by a terrestrial or satellite receiver 112, fed to a broadcast decoder 114 and converted into a usable digital stream. The encoded digital broadcast can be a subscription service, such XM Satellite Radio or Direct TV, or the encoded digital broadcast can be a commercial or public broadcasting service, such as a digital broadcast of a local television or radio station. Alternatively, a media stream comprising a webcast or audio/video stream can be fed to a stream decoder 122 which can decode and decompress and/or otherwise condition the media stream into a usable digital stream. The stream decoder 122 can decode streams encoded using a single format, or streams encoded using different formats. The digital stream produced from one or both of an analog or digital, compressed or uncompressed stream can then be analyzed and segmented 116, for example by a processor.

Segmentation of a Stream

Preferably, the digital stream is managed by temporally dividing the digital stream into segments. The segments can either be clustered into larger, associated groups of segments which can then be identified, or the segments can be individually identified and subsequently clustered based on segment identity. Segment boundaries can be located using myriad different techniques, ranging from crude to sophisticated. In one embodiment, segment boundaries can correspond to locations flagged by meta-data encoded within the digital stream. Meta-data is definitional data that provides information about other data, in this case a streamed video or audio clip. Meta-data is attached to a clip, and can include descriptive information about the context, quality and condition, and/or characteristics of the clip. The quality of meta-data is dependent on the source of the content of the meta-data, and can vary substantially. Meta-data can provide a rough flag for the beginning of a new clip or piece of media, indicating a segment boundary. Such a technique can have limited applicability, as it requires that the data stream at least partially include encoded meta-data. However, where meta-data is associated with each audio or video clip, the technique can be simple.

In an alternative embodiment, the short-term energy of the digital stream can be analyzed for points of low power within the digital stream—presumably corresponding to silences resulting from a change in a presentation from one song to another, for example—and the data stream can be segmented at each identified point of low power below a threshold. Such a technique does not rely on information other than the media content itself, and therefore can be applied to any media stream properly decoded and decompressed into a usable digital stream. However, automatic segmentation techniques can make errors, such as oversegmenting a commercial composed of speech and music, or undersegmenting a news broadcast consisting of several reports spoken by the same announcer.

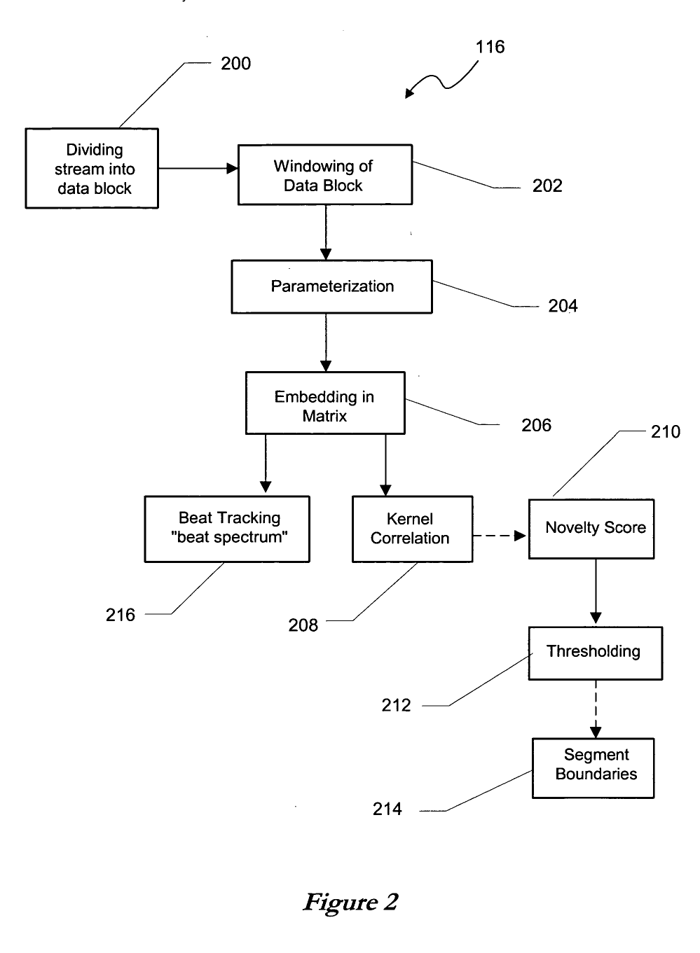

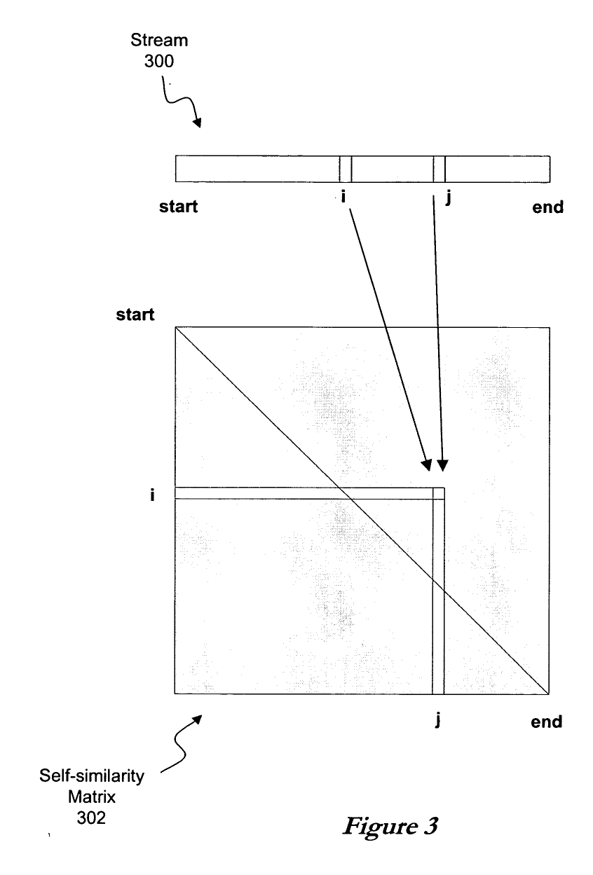

In still other embodiments, the digital stream can be segmented based on one or more structural characteristics of the digital stream identified using more sophisticated techniques. For example, points of change or novelty can be identified within the digital stream using self-similarity analysis and/or beat spectrum analysis, as described in U.S. Pat. No. 6,542,869 issued Apr. 1, 2003 to Foote. Self-similarity analysis is a non-parametric technique for analyzing a structure of a time-ordered digital stream. FIG. 2 is a flowchart illustrating the steps for performing such analysis. The digital stream can be provisionally divided into blocks of data (Step 200), with each block analyzed and segmented either independently or relative to adjacent blocks of data (e.g., using a tree structure). The block can be time windowed (Step 202), and a vector parameterization value can be calculated for each time window (Step 204). The vector parameterization can be calculated using myriad different techniques. For example, the windowed data can be parameterized using a Short Time Frame Fourier Transform (STFT) or similar frequency analysis, a Mel-Frequency Cepstral Coefficients (MFCC) analysis, a spectrogram, wavelet decomposition or any other known or later developed analysis technique. The parameterization values are used to construct a two-dimensional representation (i.e., a similarity matrix) comprising a measure of similarity or dissimilarity between two feature vectors calculated for some or all windows of a block relative to every other window of the block (Step 206). The measure of similarity can comprise, for example, a Euclidean distance measurement, a dot product, a cosine angle measurement, functions of vector statistics (such as the Kullback-Leibler distance) or any other known or later developed method of determining similarity of information vectors. Referring to FIG. 3, the similarity matrix can be constructed such that elements D(i,j) along the matrix diagonal (i.e., the super-diagonal) correspond to a similarity measurement of each element to itself. Thus, self similarity is at a maximum along the super-diagonal. The similarity matrix is a useful tool for performing multiple different analyses to refine the locations of segment boundaries.

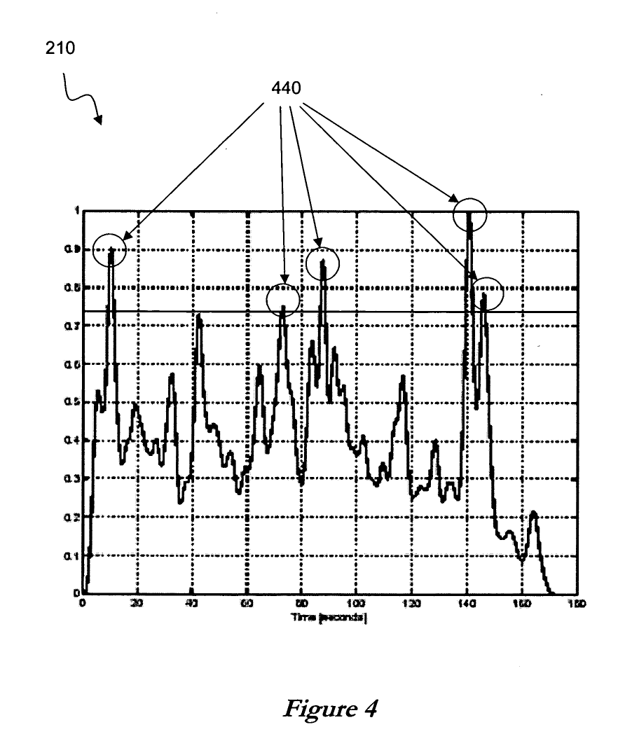

In one embodiment the self-similarity matrix can be correlated with a checkerboard kernel by calculating a cross-product of the kernel with data points adjacent to the super-diagonal (Step 208). The kernel can be as small as a 2×2 unit kernel, or as large as desired. A small kernel detects novelty on a short time scale, while increasing the kernel size decreases the time resolution, and increases the length of novel events that can be detected. The product of the kernel as it moves along the super-diagonal can be plotted as a time-indexed plot of vector distance (Step 210). The vector distance is a measure of a magnitude of dissimilarity of one window to adjacent windows (i.e., a degree of novelty). Where a magnitude of dissimilarity exceeds a predefined novelty threshold, that window can be said to be sufficiently high in magnitude to be “novel”—that is, a novelty point (Step 212). FIG. 4 illustrates an exemplary novelty plot for a block of data comprising a 150 second song calculated in accordance with one embodiment of the present invention. If, for example, the novelty threshold were defined as a 7.35 novelty score, five novelty points 440 would be defined within the 150 second block. The segment boundaries can be defined by at least some of the novelty points (Step 214). For example, the segment boundaries can correspond to each novelty point exceeding the global threshold, or a portion of the novelty points exceeding a local threshold. A local threshold can be defined by some characteristic of the novelty measure within the block itself. For example, the block can be divided into a number of segments not to exceed a maximum number, with each segment boundary being defined based on a hierarchy of novelty scores. Additionally, where the data is divided into very large blocks, for example an hour of streamed music, the novelty points can serve as useful indexes indicating points of significant change. The novelty points can be organized in a binary tree structure, with the highest-scoring novelty point becoming the root of the tree, and dividing the block into left and right sections. The highest-scoring index point in the left and right sections becomes the left and right children of the root node, and so forth recursively until there are no more novelty points that exceed a threshold. The tree structure can facilitate navigation of the novelty points. Further, the tree can be truncated at any threshold level to yield a desired number of novelty points (and hence, segments). Further still, the tree can serve as a hard division when a size of a kernel applied to the tree is reduced as the tree is descended, so that lower-level novelty points reveal increasingly fine time granularity.

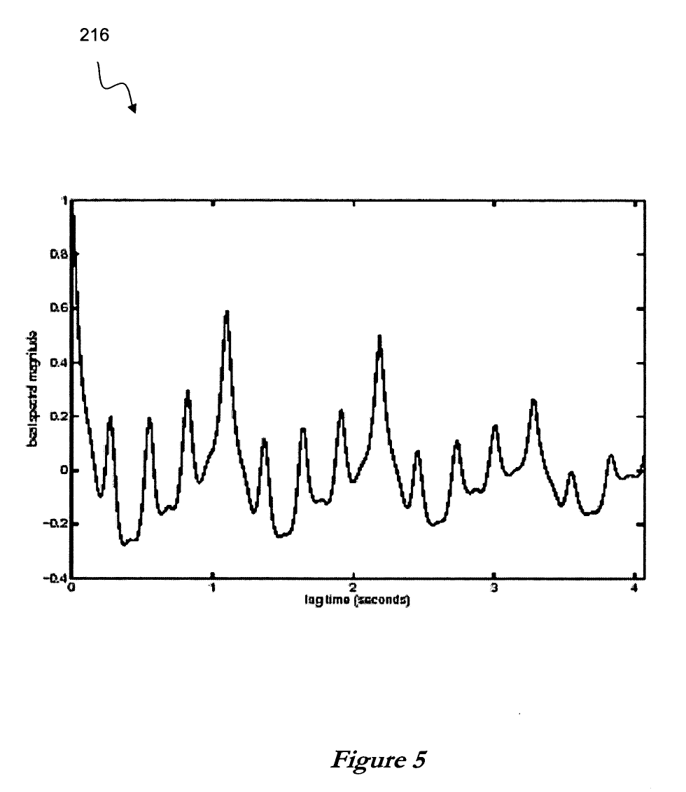

In other embodiments, beat tracking can be used as an alternative to (or in addition to) performing a kernel correlation to obtain a novelty score. For beat tracking, both the periodicity and relative strength of beats in the digital stream can be derived. In one embodiment, a beat spectrum can be generated using the similarity matrix of FIG. 2, a simple estimate of which can be calculated by summing along the super-diagonal and sub-diagonals identified from measurement of self-similarity as a function of lag, with peaks in the beat spectrum corresponding to fundamental rhythmic periodicities within the digital stream (Step 216). In an alternative embodiment, the beat spectrum can be derived from autocorrelation of the similarity matrix. A more detailed explanation is available in U.S. patent application Ser. No. 10/405,192, entitled “Method and System for Retrieving and Sequencing Music by Rhythmic Similarity”, filed on Apr. 1, 2003. FIG. 5 is an exemplary beat spectrum plot of a portion of a block of data. The periodicity of each note can be seen as well as a strong 4-note periodicity of the phrase with a sub-harmonic at 16 notes. The beat spectrum can be used as a feature vector, like spectral features or MFCCs, such that changes in the beat spectrum within the block indicates segment boundaries. Using the beat spectrum in combination with a narrow kernel novelty score can give an estimate of musical tempo, for example in a music stream. Changes in musical tempo can be detected and serve as segment boundaries with success, particularly for music streams.

In still other embodiments, any other technique for identifying transitions within and between auditory or visual works can be applied to segment the digital stream. Such techniques can include combining segmentation with other steps of a method in accordance with the present invention (e.g., segmentation and identification). For example, spectral hashing can be performed on overlapping audio clips, with each clip comprising a relatively large window on the order of seconds, rather than fractions of seconds. The result of the spectral hashing can be compared with a database, and the clip can be identified as a portion of a song, for example. A transition occurring between songs can be identified by a confused or inconclusive result and the clip can serve as a point of segmentation. A chosen method of segmenting the digital stream can depend on the content of the media stream. For example, where a media stream comprises a top-40 broadcast, a combination of beat tracking and kernel correlation may be preferred, whereas where a media source is known to comprise streaming MP3 or other audio data with associated digital metadata, simple meta-data segmentation may be preferred. Methods and systems in accordance with the present invention can include selectively applying a technique, or a combination of techniques to a digital stream, as appropriate to the content of the media stream.

While largely described in the context of auditory works, techniques for segmenting blocks of data can be applied to time-ordered works other than auditory works, as well. For example, such techniques can be applied to media streams comprising video and text. U.S. patent application Ser. No. 09/947,385 filed on Sep. 7, 2001 describes windowing and parameterization of video and text information. For example, video information can be windowed by selecting individual frames of video information and/or selecting groups of frames which are averaged together. Methods and systems in accordance with the present invention are applicable to any and all time-ordered works, and should not be construed as being limited to auditory works.

Identifying Segments

Once the digital stream has been segmented, the resulting segments can be clustered into larger groups of segments. Segments can be clustered to both locate repeated segments separated in time and correct over-segmentation errors. Given segment boundaries, a full similarity matrix of lower dimension can be generated, indexed by segment rather than time. The similarity between variable length segments is estimated using a statistical measure, as described in detail in U.S. patent application Ser. No. 10/271,407, entitled “Summarization of Digital Files”, filed on Oct. 15, 2002. The segment similarity matrix is generated by embedding inter-segment similarity between each pair of segments in a segment-indexed matrix. To determine the inter-segment similarity, a mean vector and covariance matrix can be computed from the spectral data of each segment. The inter-segment similarity can be calculated using the Kullback-Leibler (KL) distance between the mean vector and covariance matrix for each pair of segments. To cluster the segments, the segment similarity matrix is factored to find repeated or substantially similar groups of segments.

Groups of segments can be identified 110 either by using fingerprinting techniques (such as disclosed by Cano, et al. in “A Review of Audio Fingerprinting,” in Proceedings of the 2002 International Workshop on Multimedia Signal Processing, St. Thomas, US Virgin Islands, 2002) or alternatively by comparing the grouped segments to data stored within an archive, such as a server hard disk drive. Fingerprinting techniques can include, for example, finding an identical copy of a given audio waveform by comparing a reduced representation (e.g., a spectral hash) of the given audio waveform to a database of such representations. Where an external database 118 is available, such as Shazam, an appropriate fingerprinting analysis can be performed on the grouped segments to identify the content. Alternatively, where the grouped segments cannot be readily identified, where an external database is not available, or where desired, the grouped segments can be compared with one or more archived clips. Such comparison can comprise a computationally intensive analysis of the grouped segments with each archived clip, or a low level comparison of features resulting from segmentation or a fingerprint from a fingerprinting analysis with results from previous analyses associated with each archived media clip. For example, a spectral hash for each archived media clip can be associated with the respective clip and stored for comparison of a spectral hash of the grouped segment. Alternatively, the grouped segments can be identified using a detected feature (e.g., rhythm derived from beat tracking) associated with each archived media clip. For example, a beat spectrum can be calculated for the grouped segments and compared with a beat spectrum stored for each archived media clip

In other embodiments, the original segments produced during segmentation can be identified 110 prior to clustering. As with grouped segments, original segments can be identified using one or both of detected features and symbolic information from an external database 118. However, the effectiveness of fingerprinting may or may not be less robust where the original segments are spaced extremely close together in time. For example, a one second segment may be more difficult to identify than a ten second segment. In some embodiments, a local novelty threshold can be applied to a child within a tree structure, or a global novelty threshold can be increased where a segment length is identified as too short to be robustly identified. In still other embodiments, a block, or a child within a block, can be segmented and identified, and subsequently reassembled and re-segmented where an error rate during segment identification is too high. Similarly, the original segments can be identified using a detected feature and compared with an external database storing such feature data. As above, where the original segments cannot be readily identified, where an external database is not available, or where desired, the original segments can be compared with one or more archived clips. Such comparison can comprise an analysis of the original segments with each archived clip, or a low level comparison of features resulting from segmentation or a fingerprint from a fingerprinting analysis with results from previous analyses associated with each archived media clip.

Combining symbolic and feature data can depend on a user's application. For example, the segments can be ranked by artist or by rhythm, or by both using a database-like select (e.g., first select all segments by artist, then rank by rhythm). In the absence of either symbolic or feature data, the other can be applied. Once the original segments have been identified, the segments can be clustered based on associations between segments. For example, a string of ten segments can be associated with different portions (e.g., verse, chorus) of a single song. The segments can be clustered based on a common relationship between them—i.e., that they are portions of the same song.

Organizing Media Collection

As described above, once a segment (or group of segments) is identified, a comparison can be made with archived segments of a personal media collection 102. Where a segment exists within the archive 102, information about the segment can optionally be recorded, and the segment can be discarded. For example, where methods and systems in accordance with the present invention are applied to monitor a radio broadcast, a playlist can be compiled noting a frequency of occurrence of a segment, without archiving the segment each time the segment occurs (the selective organization of media segments as described herein (e.g., creating playlists, blacklisting, creating custom streams, etc.) is applied in block 106). In some embodiments, where the segment does not exist within the archive 102, the segment can simply be added to the archive 102. In other embodiments, criteria can be applied to the segment to determine whether the segment is “desired.” For example, by combining beat tracking with kernel correlation tracks having similar tempo or rhythm can be archived and added to a playlist. A user may decide that any segment over 140 bpm is risking a sprained hip, and therefore undesired. Such criteria can be valuable where, for example, methods in accordance with the present invention are applied to personal media players, such as an Apple iPod. The user may desire that only fast paced “work-out” music be loaded onto the user's iPod. In still other embodiments, the segment can be filtered through a speech and music classifier, as described in Scheirer, et al. “Construction and Evaluation for a Robust Multifeature Speech/Music Discriminator,” in Proceedings of ICASSP 97, 1997, pp. 1331-34, Munich, Germany, and all identified speech can be discarded. Such a filter can be useful, for example, where the monitored radio broadcast is a top-40 broadcast, and the user desires to discard DJ vocals, advertisements, etc., as well as any repeated segments.

Methods in accordance with embodiments of the present invention can be applied by systems to continuously monitor a radio broadcast from one or more stations simultaneously and archive the stations' playlists and select segments. The playlist can include the identity of all songs played on the one or more stations with measurements of how often each song is played. In one embodiment, every song in the database can be represented with a unique numerical identifier that can serve as a database key. If an incoming song matches a song in the database, the count associated with that key is incremented, and the time the song was broadcast can be saved in the database, along with the broadcast channel or source identifier. The relative frequency of the song in the channel's playlist can be estimated by dividing the broadcast count by the time difference between the first and most recent broadcast time. The relative frequency can also be computed across a plurality of input channels by summing the counts from different channels over a similar time extent. The system can then generate a similar broadcast, without DJ or commercial interruption, and with the added benefit that the user could override the repetition frequency for any particular song, as well as add or delete other songs to the playlist. Further, the system can alert the user to any new song that satisfies desired criteria, or add them to any automatic playlist based on metadata or audio analysis. The generated broadcast can be emitted over a speaker 104 in real-time, time delay, and/or the generated broadcast can be stored for later access and use.

Methods and systems in accordance with the present invention can be applied to a media stream and/or an archive of media clips to enable a multiplicity of applications. For example, a system can include an optical media source, such as a CD-ROM, CD-RW, DVD-ROM, etc. A CD Ripper 108 application can be incorporated into the system as an additional source of music for compiling a personal media collection 102. Such application can access an external database 118, such as Gracenote CDDB, to identify tracks from the media source. Conveniently, tracks recorded on many CD's are segmented by track, and therefore does not require segmentation analysis. Where the personal media collection is used to compile a playlist for storage on a media having a defined capacity (e.g., a CD-R), methods in accordance with the present invention can be applied to select a number of tracks from a personal music collection similar in rhythm or feel to one or more tracks chosen by the user for storage on the media. Such an application can be useful for taking advantage of extra space on a CD-R or a personal music player. Automatically suggesting extra tracks both fills storage that would otherwise be wasted, and results in a thematically coherent recording or song collection.

In other embodiments of systems and methods of the present invention, a personal music collection can be played in the “background” as a streaming audio source. Automatic track selection and sequencing generates a seamless mix from a user's personal music collection with no user overhead of sequencing or track selection. Unlike the “shuffle” capability on existing media players, this function can be tailored to ensure no jarring transitions by sequencing music by audio and rhythmic similarity. Given simple feedback capability, the system can learn user preferences, possibly adjusted for location and time, and automatically select music to fit the desired need. This application might be particularly suited for a personal audio player, where “hands off” function might be necessary (during exercise, for instance).

In still other embodiments, systems and methods of the present invention can be applied to suit particular environments, such as motor vehicles. As real-time information is more critical, an incoming broadcast can be buffered using just enough delay to enable the desired features. Given a five-minute buffer, straightforward features like commercial skip and “replay last ten seconds” can be easily implemented. Other features like song detect and replace are also possible, but time-scale modification can be necessary (depending on the desired feature) to achieve broadcast continuity without “dead air.” Real-time information like traffic reports, weather, or news headlines are particularly important for commuters. Methods in accordance with the present invention can be applied to automatically detect and buffer such media clips, especially if they occur at known times. Thus, traffic information can be available at the touch of a button, and real-time newscasts can be inserted into a buffered stream.

Retail music websites or record stores are environments where methods and systems in accordance with the present invention can further be applied. It is increasingly common that a user desires to skim a large amount of digital audio. Retail music websites make a huge amount of audio available for audition, and given current audio search engines, a potentially large number of results must be auditioned to determine whether they satisfy the user's information need. Methods and systems in accordance with the present invention can offer a rapid way to browse and skim music. Through segmentation 116, significant sections within a song, such as verses and refrains can be robustly and automatically extracted. A “skip to next section” function allows significant portions of a song to be rapidly audited, which is not possible with current technology. For example, a user might wish to ascertain whether a particular song is a song remembered from a single hearing on the radio (assuming the radio is not equipped with systems for applying methods of the present invention, whereby a playlist can be compiled). The user might only remember a particular refrain or “hook” and be unfamiliar with (or have missed) a slow introduction. Using the “skip to next section” button, the user can quickly locate the chorus with the hook. If the song is not the one remembered, the user can be certain that the most significant parts of the song have been heard, without taking the time to listen to the song in its entirety. Further, such media auditing can be useful for scanning media available over peer-to-peer services, where quality is often suspect, as files are truncated or poorly encoded, or have been accidentally or deliberately mislabeled.

Handheld compressed audio players such as the Rio or the Apple iPod have proliferated and are used in a variety of environments, from work-outs at the gym to cross-country trips. Already, a small device can easily store a typical user's CD collection in its entirety: literally weeks of uninterrupted music. This enormous storage capacity combined with a severely size constrained user interface makes a strong case for novel automatic data management techniques. Methods in accordance with the present invention can be applied to generate automatic playlists, relieving the user of the need to locate and schedule desired music. Automatically sequencing music by rhythmic similarity offers the benefit of hands-off operation, as the user need not attend to the device at the end of every song. For exercise or sports use, a rhythmic similarity measure could select music with a tempo compatible with the user's exercise speed as determined by an accelerometer or similar device. Moreover, because nearly all players interface with a PC for file transfer, computationally-intensive indexing tasks can be performed on a host computer. In this case, index results (such as a beat tracking) can be pre-computed and transferred to the device for later use. Thus little hardware or software is needed to support the added functions, a valuable consideration in consumer products where it is always desirable to keep unit costs low.

In still further embodiments, methods and systems in accordance with the present invention can be applied to anticipate a user's tastes. Many music consumers have strong preferences about the music they prefer. An “automatic blacklist” function can apply user feedback to learn the audio characteristics of disliked songs, artists, or genres. For example, a simple interface such as a button can be pressed during playback of a disliked work. An alternative work can be immediately substituted (e.g., the next work in a playlist). The disliked work can be “flagged” or otherwise identified for analysis, and a blacklist can be generated and updated by adding the characteristics of the flagged work to the blacklist. The blacklist can be used for a number of functions: to discard works based on rejection criteria generated using the blacklist, to prioritize playlists, to hide undesirable search results, and to perform real-time “sanitizing” of broadcast audio based on the rejection criteria. Given a suitable buffer, blacklisted songs can be automatically detected and replaced during broadcast harvesting, or even during a real-time broadcast. Conversely, a well-liked work can be flagged, and a whitelist can be generated and updated by adding the characteristics of the flagged work to the whitelist. The whitelist can similarly be used for a number of functions: storing works based on preferred criteria generated using the whitelist, to prioritize playlists, to preferentially list desirable search results, and to perform real-time sanitizing of broadcast audio by accepting, rather than replacing or rejecting, works based on the preferred criteria.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A method for generating a library of media segments from a media stream, comprising:
receiving the media stream;
identifying one or more boundary points within the media stream; and
creating a plurality of media segments based on said one or more boundary points.

2. The method of claim 1, wherein identifying one or more boundary points includes:
defining a novelty threshold; and
comparing the media stream to said novelty threshold;
wherein said one or more boundary points exceeds said novelty threshold.

3. The method of claim 2, wherein comparing the media stream to said novelty threshold includes:
sampling a portion of the media stream as a plurality of windows; and
calculating a plurality of vectors corresponding to said plurality of windows;
generating a matrix using said plurality of vectors;
calculating a product of said matrix and a kernel to determine a novelty score of said portion of the media stream; and
comparing said novelty score of said portion of the media stream to said novelty threshold.

4. The method of claim 1, wherein receiving the media stream includes decoding the media stream.

5. The method of claim 1, wherein the media stream is at least one of an analog stream and a digital stream.

6. The method of claim 1, further comprising:
identifying metadata for at least one of said plurality of media segments; and
associating said metadata with a corresponding media segment from said plurality of media segments.

7. The method of claim 6, wherein identifying metadata includes calculating a reduced representation for said at least one media segment.

8. The method of claim 7, wherein identifying said metadata further includes:
comparing said reduced representation to a metadata database.

9. The method of claim 6, wherein identifying metadata includes calculating a beat spectrum for said at least one media segment.

10. The method of claim 9, wherein identifying said metadata further includes comparing said beat spectrum to a metadata database.

11. The method of claim 6, further comprising:
comparing said at least one media segment having associated metadata with at least one stored media segment from a media segment database.
adding said at least one media segment having associated metadata to the media segment database.

12. The method of claim 11, wherein comparing said at least one media segment includes:
calculating a reduced representation for said at least one media segment; and
comparing said reduced representation of said at least one media segment to a reduced representation of the at least one stored media segment.

13. The method of claim 11, wherein comparing said at least one media segment includes:
calculating a beat spectrum for said at least one media segment; and
comparing said beat spectrum of said at least one media segment to a beat spectrum of a plurality of stored media segments.

14. A method of creating a custom stream from one or more media streams, comprising:
receiving the one or more media streams;
identifying one or more boundary points within the one or more media stream;
creating a plurality of media segments based on said one or more boundary points;
identifying one or more of the plurality of media segments;
selecting at least one of the one or more media segments; and
creating a custom stream including the at least one media segment.

15. The method of claim 14, further including:
emitting the custom stream.

16. The method of claim 14, wherein identifying one or more boundary points includes:
defining a novelty threshold; and
comparing the media stream to said novelty threshold;
wherein said one or more boundary points exceeds said novelty threshold.

17. The method of claim 16, wherein comparing the media stream to said novelty threshold includes:
sampling a portion of the media stream as a plurality of windows; and
calculating a plurality of vectors corresponding to said plurality of windows;
generating a matrix using said plurality of vectors;
calculating a product of said matrix and a kernel to determine a novelty score of said portion of the media stream; and
comparing said novelty score of said portion of the media stream to said novelty threshold.

18. The method of claim 14, wherein selecting at least one of the one or more media segments includes:
measuring a tempo of the one or more media segments; and
choosing at least one media segment based on the tempo.

19. The method of claim 14, wherein selecting at least one of the one or more media segments includes:
measuring one or more characteristics of the one or more media segments; and
choosing at least one media segment based on a comparison of at least one of the one or more characteristics to a criterion.

20. The method of claim 19, wherein the criterion includes at least one of tempo, frequency of occurrence, and media type.

21. The method of claim 14, further comprising:
flagging at least one of the one or more media segments; and
identifying selection criteria from the at least one media segment.

22. The method of claim 21, wherein selecting at least one of the one or more media segments further includes:
comparing the one or more media segments to the selection criteria.

23. The method of claim 22, further comprising:
rejecting the one or more media segments based on the selection criteria.

24. A system for emitting a customized media stream created from one or more media streams, comprising:
a processor to:
segment the one or more media streams into a plurality of media segments;
select at least one of the plurality of media segments; and
create the customized media stream from the at least one media segments; and
a speaker to emit the customized media stream.

25. The system of claim 24, further comprising a receiver to receive the one or more media streams.
